(19) United States
(12) Patent Application Publication
(10) Pub. No.: US 2023/0131905 A1
(43) Pub. Date: Apr. 27, 2023

(54) CIP CONTROL SURVEILLANCE SYSTEM AND APPLICATION OF THE SYSTEM

(71) Applicant: HABI Tech. I/S, Haslev (DK)

(72) Inventors: Birger Elholm Madsen, Haslev (DK); Hans Ejnar Andersen, Balibago, Angeles City (PH)

(21) Appl. No.: 17/918,766

(22) PCT Filed: Apr. 8, 2021
(86) PCT No.: PCT/EP2021/059220

§ 371 Date: Oct. 13, 2022

(30) Foreign Application Priority Data
Apr. 14, 2020 (DK) PA 2020 00433

(51) Int. Cl. B08B 9/032; B08B 13/00; B08B 9/08

(52) U.S. Cl. CPC B08B 9/0325; B08B 13/00; B08B 9/08; B08B 2209/08; B08B 2209/032

(57) ABSTRACT

A Clean-In-Place (CIP) control surveillance system has all streams forward and return monitored and accounted for, where values for each step may be stored in a data base. The CIP system used to clean one or more objects includes a primary tank for primary cleaning media, optionally a secondary tank for secondary cleaning media, a supply of freshwater, one or more forward lines, one or more return lines returning liquid, and valves directing the flow through tanks and pipes of the CIP Process Plant. The system further includes a sensors and transmitters measuring concentration in the forward line and return line and transmitting a value for the concentration to a controller, a sensor and transmitter measuring volume or mass flow in the forward line and return line, and a controller or computer configured to compare in and out values for a period.

The present invention relates to a CIP (Clean-In-Place) Control Surveillance System (CIP CSS) where all streams forward and return are monitored and accounted for and where values for each step may be stored in a data base.

### BACKGROUND OF THE INVENTION

It is known to measure flows and concentration levels of streams in a CIP-system in order to document that the system is working correctly.

US 2011/0197920 A1 discloses a monitoring and recording device for a CIP-system and provides a controller and recorder for multiple chemical concentrations, temperature, flow rate, air flow and valve stem position in a CIP-system. A system according to this document comprises flowmeters (110, 111, 113, 114) measuring flows of different liquids into tanks containing cleaning media (30, 40, 50, 60) and each tank is provided with a conductivity sensor (36, 46, 56, 66), also, the system comprises conductivity sensors (73, 74) placed respectively in the fluid supply line (16) and the fluid return line (18). All measured values are recorded by a controller (78). When a flow meter registers a flow into a tank, the conductivity sensor of the tank should register an increased conductivity value providing a validation that the pumps are working properly ([0065]).

The prior art does not teach to measure the amounts of chemical or fluid flowing to and from the object to be cleaned, the prior art therefore does not provide a method to set an alarm when cleaning chemicals are not returned through the return line from the object.

### SUMMARY OF THE INVENTION

Thus, an object of the present invention is to provide a CIP surveillance system and process which system and process monitors whether cleaning media may have been left inside or within the object after the CIP is completed subsequently with the risk of being mixed into the product.

Thus, one aspect of the invention relates to a CIP system for cleaning one or more object(s) comprising
a primary tank (1) for primary cleaning media,
optionally a secondary tank (2) for secondary cleaning media,
a supply of freshwater (20),
one or more forward lines (4) forwarding liquid in form of primary or e.g. secondary, cleaning media or water from the CIP process plant to one or more objects (A, B, . . . , X) where an object may comprise one unit or a part of a unit such as a tank or pipeline or a combination of units and each object is subjected to a separate CIP flow,
one or more return lines (5) returning liquid in form of primary, e.g. secondary cleaning media or water from the object to the CIP process plant,
valves (12, 13, 14, 7, 8, 6a,) directing the flow through tanks and pipes of the CIP Process Plant, where each forward line (4) comprises valves (12, 13, 14) directing liquid from either the supply of freshwater or from a tank into a forward line (4), and each return line (5) comprises inlet valves (7, 8, 6a,) directing liquid from the return line (5) into a tank (1, 2,) or into a drain (6),
   which system further comprises
a sensor and transmitter (34) measuring concentration in the forward line 4 to an object at a position down stream of inlets/outlets valve from tank or supply and upstream of the inlet for the object and transmitting a value for the concentration to a controller, and
a sensor and transmitter (35) measuring volume or mass flow (35) in the forward line (4) to the object at a position down stream of inlets/outlets valves from tank or supply and upstream of the inlet for the object, and
a sensor and transmitter (33) measuring concentration in the return line (5) from the object at a position downstream of the object and upstream of any inlet/outlet valves to or from tanks or supply and transmitting a value for the concentration to the controller, and
a sensor and transmitter (36) measuring volume or mass flow in the return line (5) from the object at a position downstream of the object and upstream of any inlet/outlet valves to or from tanks or supply, and
means such as a controller or computer configured to calculate and compare in and out values for concentration of cleaning media and for flow or mass for a period.

The combination of sensors defined above makes it possible to establish both the amount of cleaning chemical or cleaning media entering an object to be cleaned, and the amount of cleaning chemical or cleaning media leaving same object, as well as total volume or mass entering and leaving an object.

The comparison made by the controller or computer may determine that a CIP process has been performed in an acceptable manner or that a CIP process is performed in an unacceptable manner. If the CIP process is performed in an acceptable manner, the next step may be a production step, if the CIP process is performed in an unacceptable manner, the next step may be an alarm or a closing of the units belonging to the cleaned system.

According to an embodiment of this first aspect, the sensor (35, 36) measuring volume or mass flow in the forward line (4) or in the return line (5) may be a density sensor.

According to an embodiment of this first aspect, the sensor (34, 33) measuring concentration in the forward line (4) or in the return line (5) may be a conductivity sensor.

According to an embodiment of this first aspect, the system may further comprise an air eliminator (37) positioned between the object (A, B, . . . , X) and the first downstream sensor.

According to an embodiment of this first aspect, the system may comprise or have access to a database configured to receive and store the measured values and means configured to calculate a sum of measured values for corresponding periods or corresponding amounts of liquid in and out of object, e.g. corresponding periods or corresponding amounts of liquid may refer to a complete step or part of a step in which cleaning media is used.

Thus, a second aspect of the invention relates to a method for monitoring a CIP process in a CIP system for cleaning one or more objects comprising the following units:
a primary tank (1) for primary cleaning media,
optionally a secondary tank (2) for secondary cleaning media,
a supply of freshwater (20),
one or more forward lines (4) forwarding liquid in form of primary or e.g. secondary, cleaning media or water from the CIP process plant to one or more objects (A, B, . . . , X) where one object may comprise one unit or a part of a unit such as a tank or pipeline or a combination of units and each object is subjected to a separate CIP flow,
one or more return lines (5) returning liquid in form of primary, e.g. secondary cleaning media or water from the object to the CIP process plant,
valves (12, 13, 14, 7, 8, 6a) directing the liquid in and out of tanks and lines of the CIP system, where each forward line (4) comprises valves (12, 13, 14) directing liquid from either the supply of freshwater or from a tank into a forward line (4), and each return line (5) comprises inlet valves (7, 8, 6a,) directing liquid from the return line (5) into a tank (1, 2,) or into a drain (6), wherein the process comprises the following step:
   a. measuring concentration of a cleaning media and measuring flow entering into an object,
   b. determining a value Vᵢₙ for amount of cleaning media entering the object during a first period where cleaning media flows into the object,
   c. measuring concentration of a cleaning media and measuring flow exciting the object,
   d. determining a value Vₒᵤₜ for amount of cleaning media leaving the object during a second period which second period corresponds to the first period in such a way that the cleaning media entering the object in the first period should leave the object during the second period.

According to an embodiment of the second aspect, the method further comprises the following steps:

e. comparing the amount of cleaning media Vₒᵤₜ exciting the object with the amount of cleaning media Vᵢₙ entering the object and determining a difference value ΔV,
f. determining whether difference value ΔV differs significantly from a standard value V₀.

According to an embodiment of the second aspect, the system may set a flag or a bit or an alarm or similar, if ΔV differs significantly from the standard value V₀.

The flag may be used to automatically or manually shut down a production facility or it may be used to shut down the CIP system in question. A flag may be used to send an alarm to identified persons, or it may be used to sound a general alarm.

According to an embodiment of the second aspect, the standard value V₀ is estimated for a CIP process for an object and used to estimate whether the difference value ΔV differs significantly from a standard value V₀.

According to an embodiment of the second aspect, a first standard value V₀ for cleaning an object (A, B) may be estimated by running one or more CIP process(es) in a clean object, i.e. during this run the object is to have a standard value V₀ estimated, the object is either clean or has not been used before.

According to an embodiment of the second aspect, the standard value V₀ for cleaning an object (A, B) is estimated by running a CIP process for the object at least 5 times, or at least 10 times, and calculating a mean value and a standard deviation for the number of processes, further the standard value V₀ may be improved over time as more CIP processes are run during production by establishing updated values for mean value and standard deviation.

According to a preferred embodiment, the standard value V₀ for cleaning an object (A, B) is estimated after a first CIP on a clean object. Hereafter the standard value V₀ will continuously be optimized as more data is collected and processed in the database from the CIP controller or other controllers.

### BRIEF DESCRIPTION OF THE FIGURES

FIG. 1 shows a prior art CIP-system,

FIG. 2 shows an embodiment of a CIP system according to the invention.

The present invention will now be described in more detail in the following.

### DETAILED DESCRIPTION OF THE INVENTION

### Definitions

Prior to discussing the present invention in further details, the following terms and conventions will first be defined:

In general—this expression is used if the feature following the words may be combined with all embodiments of the invention.

Sensor/transmitter—refers to a set comprising a sensor and a transmitter measuring a value and transmitting the value to a receiving unit such as a controller. Often the sensor and the transmitter are joined in a single unit.

CIP Process Plant—comprises the physical units designated for cleaning purposes such as a primary tank for primary cleaning media, a secondary tank for secondary cleaning media, a supply of freshwater, forward lines forwarding liquid to an object, etc., the CIP system also includes the object to be cleaned.

It should be noted that embodiments and features described in the context of one of the aspects of the present invention also apply to the other aspects of the invention.

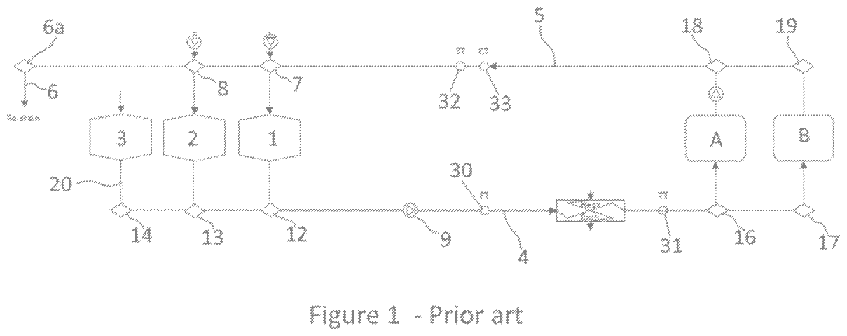

FIG. 1 shows a sample of a simple prior art CIP-system. A traditional CIP process plant as well as a CIP process plant according to the invention may also comprise one or more of the following units:
Pre-flush soil/water recovery tank(s)
Reusable water recovery tank
Multiple NaOH tanks
Multiple HNO₃ tanks
Recovery tank for diluted NaOH
Recovery tank for diluted HNO₃
Hot- or cold-water disinfection tank

FIG. 1 shows a prior art CIP system. The CIP system comprises a lye tank 1, an acid tank 2, a fresh water supply 20 e.g. in form of a fresh water tank 3, a drain 6 and two objects, a first object A and a second object B. The system comprises a forward line 4 (CIP-F) transporting CIP liquids forward to the object(s) and a return line 5 (CIP-R) returning CIP liquids to the tanks or drain. A forward pump 9 forces liquid from the tanks to the object.

An object is either a single unit such as a tank or pipeline or other process equipment, or an object is a process line comprising a combination of units. The CIP inlet to an object is defined by an inlet valve 16 or 17 and the CIP outlet from an object is defined by an outlet valve 18 or 19, the inlet and/or the outlet valves to the object(s) are only opened during the CIP process, during operation or production both inlet and outlet valves to the object are closed preventing cleaning media or water used for cleaning to mix with product. A pump is shown downstream of the object A, a pump may be needed if the object A is a tank as a forward pump 9 placed upstream of the object will not be able to remove liquid from a tank.

One CIP tank system may be used for cleaning of one object or for cleaning of several objects, if used for several objects the objects may be placed in a parallel structure allowing for common use of the forward and returning lines 4, 5 or each object may comprise individual forward and return lines 4, 5 with necessary inlet and outlet valves.

The lye tank 1 comprises an inlet valve 7 and an outlet valve 12. When the inlet valve 7 is open liquid is directed from the return line 5 to the lye tank 1 and when the inlet valve 7 is closed liquid does not enter into the lye tank 1. When the outlet valve 12 is open, liquid is directed from the lye tank 1 into the forward line 4.

The acid tank 2 comprises an inlet valve 8 and an outlet valve 13. When the inlet valve 8 is open liquid is directed from the return line 5 to the acid tank 2 and when the inlet valve 8 is closed liquid does not enter into the acid tank 2. When the outlet valve 13 is open, liquid is directed from the acid tank 2 into the forward line 4.

If liquid returned from the object(s) A and/or B through the return line 5 does not enter a tank, it may enter into the drain 6 by opening of a drain valve 6a. The CIP system of FIG. 1 comprises a freshwater supply 20 which may e.g. comprise a freshwater tank 3. Alternatively, the fresh water supply may comprise a freshwater line.

A traditional CIP-system may comprise a flow sensor and flow transmitter 30 on the forward line 4. This flow sensor is normally positioned on the forward line 4 in order to establish that the flow in the forward line 4 is as high as expected as the turbulence of the flow contributes to make the CIP cleaning efficient. If the flow is lower than expected, the pump 9 may be mal-functioning or the flow from a tank may be disturbed. I.e. the flow sensor/transmitter 30 is present to make sure that the CIP process is running as intended. The forward line 4 may also comprise a concentration sensor and transmitter measuring the concentration and transmitting the measurement, the purpose of such a sensor is normally to establish or document that the flow towards an object has a minimum content of cleaning media or to establish an expected trend for the concentration of cleaning media.

Further, a traditional CIP-system normally comprises a conductivity sensor/transmitter 33 in the return line 5, this sensor 33 is present in order to establish when inlet valves 7, 8 to cleaning media tanks 1 and 2 are to be open and closed in order for the CIP-system to direct the flow either to the cleaning media tank or to drain 6.

A CIP cycle in a prior art system normally comprises the following combination of steps, however other combinations may also apply:

### 1) Pre-Flushing

The pre-flush step uses water from a fresh water supply 20 to remove gross soil. If a CIP system comprises a water recovery tank used to collect used water from the system, recovered water may be used in this step.

During the pre-flushing step the outlet valve 14 for the fresh water tank 3 is opened, the inlet valve 16 or 17 to object A or B is opened, the outlet valve 18 or 19 from the object A or B is opened, and the valve to the drain 6a is opened. As the forward pump 9 is turned on, water from the freshwater tank 3 is pumped through the object A or B and into the drain 6 for a pre-set time or volume. When the pre-flush step is finish, the outlet valve 14 from the freshwater tank 3 is closed, and the outlet valve 12 of lye tank is opened.

### 2) Pushing Used Water Out of CIP Lines Before Caustic Wash.

To start the caustic wash, the outlet valve 12 of the lye tank 1 is opened and the forward pump 9 forces the lye from the tank 1 to the object A or B via the forward line 4. The valves to the drain will remain open until a concentration sensor/transmitter 33 placed in the return line 5 registers a content of lye in the return liquid. This step is called “Lye push”.

3) Caustic Wash with or without Recovery to Remove Residual Adhering Debris.

When a content of lye above a pre-set value is registered in the return liquid in the return line 5, the valve(s) to the drain valve 6a is closed and the inlet valve 7 to the lye tank 1 is opened where after circulation of lye through the object A or B and the lye tank 1 may continue for pre-set time or volume. This step is called “Lye wash”. When lye wash step finish, the outlet valve 12 from the lye tank 1 is closed, and the outlet valve 14 of the freshwater supply 20 is opened.

4) Intermediate Rinse to Clear Caustic from the System.

To clear the object and CIP lines for lye liquid, a sufficient water plug is pushed through the CIP lines and the object by opening of the outlet valve 14 of the freshwater tank or another water supply for a pre-set time or volume. The water plug is forced through the object A or B, either by the forward pump 9 or by a downstream pump, and into the lye tank 1 until the conductivity registered in the liquid in the return line 5 is below a pre-set value or if the lye tank 1 is full, hereafter the water plug may be led to drain 6 until e.g. acid is detected registered in the return line 5 or for a desired time or volume When the intermediate rinse step finish, the outlet valve 14 from freshwater supply is closed, and the outlet valve 13 of the acid tank 2 is opened.

### 5) Pushing Used Water Out of CIP Lines Before Acid Wash.

To start the acid wash, the outlet valve 13 of the acid tank 2 is opened and the forward pump 9 forces the acid from the tank 2 to the object A or B via forward line 4. The used water is normally pushed into the drain 6 i.e. the drain valve 6a is open, until the concentration sensor/transmitter 33 placed in the return line 5 registers a pre-set content of acid in the return liquid. This step is called “Acid push”.

6) Acid Wash with or without Recovery to Remove Mineral Scale.

When a content of acid above a pre-set value is registered in the return liquid in the return line 5, the drain valve 6a is closed and the inlet valve 8 to the acid tank 2 is opened where after circulation of acid through the object A or B and the acid tank 2 may be continued for pre-set time or volume. This step is called “Acid wash”. When acid wash step finish, the outlet valve 13 from the acid tank 2 is closed, and the outlet valve 14 of the fresh water supply 20 is opened.

### 7) Pushing Acid Out of CIP Lines Before Final Rinse.

To clear the object and CIP lines of chemicals, the outlet valve 13 of the acid tank 2 is closed, the outlet valve 14 from freshwater supply 20 is opened and freshwater is pushed through the CIP lines and the object A or B. Normally the inlet valve 8 to the acid tank 2 is opened, and used acid containing liquid is pushed into the acid tank 2 until a concentration sensor/transmitter 33 placed in the return line 5 registers a pre-set content of acid in the return liquid or the acid tank 2 is full. This step is called “Freshwater push”. When freshwater push is step finish, the inlet valve 8 to the acid tank 2 is closed, and the drain valve 6a is opened.

8) Final Rinse to Clear Remaining Chemicals from the System.

This step of the CIP procedure is to remove remaining chemicals from the object. Fresh water is forced from the fresh water supply 20 via forward line 4 for a pre-set time or volume. This step is called “final rinse”

### 9) Sterilizing

Optionally, the last step of the CIP procedure may be sterilizing of the CIP lines and the object, either by circulating fresh hot water over a hot water tank or by circulating cold water over a tank containing a sterilizing agent or by injecting a sterilizing agent directly into the forward line 4 together with freshwater for a pre-set time or volume.

A CIP system according to the invention may comprise the same units/parts as an above described traditional CIP system, and the cleaning ability of a CIP system according to the invention compared to a traditional CIP system is the same as far as a CIP system according to the invention comprises the same units as a traditional CIP system.

According to the invention, a CIP surveillance system is added to a traditional CIP system, i.e. besides cleaning one or more object as a traditional CIP system, the invention makes it possible to monitor incoming and outgoing amounts of cleaning chemicals and/or volume or mass in respect of an object and e.g. set an alarm if the outgoing amount of cleaning chemical deviates from the expected amount.

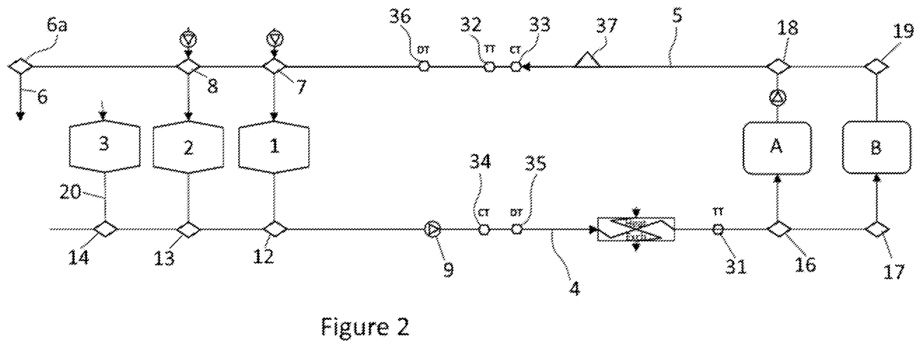

FIG. 2 shows an embodiment of a CIP system according to the invention. This embodiment comprises a volume or density sensor/transmitter 35 at the forward line 4, a conductivity sensor/transmitter 34 at the forward line 4, an air eliminator 37 at the return line 5, a volume or density sensor/transmitter 36 at the return line 5, a conductivity sensor/transmitter 33 at the return line 5 and a not shown controller.

A surveillance system according to the invention may be established on an existing CIP system which may already comprise one or more of the necessary sensors/transmitters, and which may also comprise a controller. The system according to the invention may then be established by configuring a controller to read and store relevant data from the existing sensors/transmitters in a database and compare designated values.

Alternatively, an existing CIP system may not comprise any of the sensors/transmitters, or the existing CIP system may comprise all the sensors/transmitters, needed to establish an adequate surveillance system and then new sensors/transmitters must be added to the existing CIP system.

The controller configured to read, store and compare the relevant data may be a controller already present in an existing system, but the controller may also be a new unit such as a separate PLC with a compensation data base. “Separate PLC” indicates that the controller which controls this surveillance procedure may be different from the controller controlling the CIP procedure.

The control surveillance system of the invention is in operation during operational steps where a cleaning media such as lye or acid is may be present at the object A, B, e.g. in the lye washing step, an intermediate flush such as lye push or acid push, an acid washing and a final flush. E.g., the system may be functioning in one or all of the steps 2-7 as described above.

When a cleaning media is forwarded to an object, the liquid passes through the forward line 4. When cleaning media such as lye i.e. NaOH or acid e.g. HNO₃ during operation is forwarded to the object A, B a value for the flow is measured (l/h or kg/h) e.g. by a mass flow meter such as e.g. a volume or density sensor/transmitter 35, also the concentration is measured (mole/kg) e.g. by a conductivity sensor/transmitter 34.

The most common way of measuring concentration of a liquid in process control is by measuring the conductivity of the liquid as the conductivity is used to establish the number of ions in a liquid. Normally, the conductivity is measured in “Siemens” or “milli siemens” or “milliohms”, which may be converted into ppm (parts per million) by multiplying microohms or micro siemens by 0.64 to obtain ppm: concentration in ppm=conductivity in microohms x 0.64. It might be more relevant to know molarity rather than ppm for a solution, molarity may be calculated by following principles: ppm=0.001 g of solute in 1 liter of solution (a solute is the substance dissolved into the solvent to make up the solution). Molarity=moles/liter, so by taking the atomic weight (grams/moles) of the solute (found either in the periodic table or on the solute bottle's label) it is possible to calculate molarity: ppm (grams/liter) divided by atomic weight (grams/mole) equals molarity (moles/liter).

When the phrase “measuring concentration” is used in the present application it should be understood to comprise all direct and indirect ways of establishing the concentration of a component in a liquid.

The amount of cleaning media in chemical units (e.g. calculated as mole/volume or mass/time unit) entering the object A or B, Vᵢₙ, may then be calculated e.g. by multiplying corresponding values of concentration and flow (volume or mass/time) registered at given scan times and the calculated values may be summed up for a given period. The scan times may be at least once every 100 millisecond or at least once every 50 millisecond or at least every 25 millisecond or at least every 10 milliseconds.

Such a period may represent one step, or several steps relating to cleaning with one cleaning chemical, or all steps relating to cleaning with all chemicals, and the summed up calculated values may be registered and possibly visualized e.g. as “chemical units forward”.

When a liquid return to the CIP system from an object A or B, all liquid returns through the dedicated return line 5, the liquid may first pass an air eliminator 37 to ensure more accurate readings of the downstream instruments.

Just as for the outgoing media or liquid, the amount of cleaning media in chemical units (e.g. calculated as mole/volume or mass/time unit) leaving the object A or B, Vₒᵤₜ, may be calculated e.g. by multiplying corresponding values of concentration and flow (volume or mass/time) registered at given scan times (typically 50 mS (milli seconds)) and the calculated values may be summed up for a given period i.e. the same period as for the liquid entering the object which period may represent one step, or several steps relating to cleaning with one cleaning chemical, or all steps relating to cleaning with all chemicals, and the summed up calculated values may be registered and possibly visualized e.g. as “chemical units return”.

When cleaning media such as lye i.e. NaOH or acid e.g. HNO₃ is returned from the object A, B a value for the flow is measured (kg/h or l/h) e.g. by a mass flow meter such as e.g. a density sensor/transmitter 36, also the concentration is measured (e.g. measured as Siemens or ohm and e.g. converted to mole/kg) e.g. by a conductivity sensor/transmitter 33.

The summation may be done e.g. for a complete CIP circuit, or the summation may be done for a step in the CIP process e.g. for the lye washing step or for the acid washing step etc. Also, the summation may be done for a pre-set time period.

In general, a surveillance step starts when the outlet valve 12 or 13 from a tank 1, 2 containing cleaning media opens and the surveillance step ends when the same cleaning media is detected as being absent by the sensor the sensor 33 in the return liquid. Alternatively, a surveillance step may end when a given volume or time has passed, or it may end if the CIP controller enters a step where the media for sure is absent e.g. pre-flush.

The measured values e.g. both the individual measured values obtained at a scan and the summated values, may be registered and stored in a data base either locally in the controller or on a server or similar external unit which may be accessed by the controller.

A controller can access the values and calculate a difference value ΔV, and if the difference value ΔV between the forward measured value and return measured value is estimated as being too big compared to a pre-set value V₀, i.e. ΔV>>V₀, then the CIP CSS system may block the whole CIP system from operation and/or shut down by closing relevant valves and turning of pump(s) and/or alarm/warnings may be sent to relevant persons or departments of the facility.

During a CIP circuit some cleaning chemicals may normally be lost during pulsing of valves during which operation cleaning media is pushed through a valve and to drain in order to clean it properly, and also an amount of cleaning chemicals may be consumed when cleaning chemicals react with soil originating from the production in the object, thus the measured return value may during normal operating conditions differ from the measured forward value, and normally the measured return value is smaller than the measured forward value of a CIP process, also the return value may be higher if the cleaning media has reacted into smaller units having an increased number of ions.

However, having knowledge of the object to be cleaned and the CIP system as such, it may be possible to estimate a loss value or a first standard difference V₀ when the CIP system is started and the CIP process is run for the first time.

Estimation of loss value or standard difference V₀ for a given process, may be based on the following information:
1. Number and type of valves and/or other components for pulsing at the object
2. Time and how often the pulsing of the valves and/other components occur
3. Product of the object prior to CIP
4. Production time of the object prior to CIP
5. Information collected from other control systems in the facility e.g. production controllers and/or similar CIP systems

Other factors depending on the nature of soil and object may influence the V₀ value of a specific process and parameters compensating for, such factors may be stored in the control system

The loss value or standard difference V₀ for a CIP process may be used for the first CIP circuit or for a first series of CIP circuits.

When a CIP circuit has been run for a certain number of times, it may be possible to calculate and adjust the measured loss value or a measured standard difference V₀ for the specific CIP process, if the initial standard difference V₀ for the CIP process causes errors.

In general, the more CIP circuits that has been performed on an object the more accurate comparison of the forward and return “chemical units” counters can be done as previous values of the loss value or standard difference V₀ for the CIP process may be used to adjust the applied value.

1. A Clean-In-Place (CIP) system used to clean of one or more objects comprising:
a primary tank for primary cleaning media;
optionally a secondary tank for secondary cleaning media;
a supply of freshwater;
one or more forward lines forwarding liquid in form of primary or secondary cleaning media or water from the CIP process plant to one or more objects where one object may comprise one unit or a part of a unit such as a tank or pipeline or a combination of units and each object is subjected to a separate CIP flow;
one or more return lines returning liquid in form of primary or secondary cleaning media or water from the object to the CIP process plant;
valves directing the flow through tanks and pipes of the CIP process plant, where each forward line comprises valves directing liquid from either the supply of freshwater or from a tank into a forward line, and each return line comprises inlet valves directing liquid from the return line into a tank or into a drain;
wherein the system comprises:
a sensor and transmitter measuring concentration in the forward line 4 to an object at a position downstream of inlets/outlets valve from tank or supply and upstream of the inlet for the object and transmitting a value for the concentration to a controller; and
a sensor and transmitter measuring volume or mass flow in the forward line to the object at a position downstream of inlets/outlets valves from tank or supply and upstream of the inlet for the object; and
a sensor and transmitter measuring concentration in the return line from the object at a position downstream of the object and upstream of any inlet/outlet valves to or from tanks or supply and transmitting a value for the concentration to the controller; and
a sensor and transmitter measuring volume or mass flow in the return line from the object at a position downstream of the object and upstream of any inlet/outlet valves to or from tanks or supply; and
a controller or computer configured to compare in and out values for a period.

2. The CIP system according to claim 1, wherein the sensor measuring volume or mass flow in the forward line or in the return line is a density sensor.

3. The CIP system according to claim 1, wherein the sensor measuring concentration in the forward line or in the return line is a conductivity sensor.

4. The CIP system according to claim 1, wherein an air eliminator is positioned between the object and the first downstream sensor.

5. The CIP system according to claim 1, wherein the system comprises a database configured to receive and store the measured values and means configured to calculate a sum of measured values for corresponding periods or corresponding amounts of liquid in and out of object, normally corresponding periods or corresponding amounts of liquid refer to a step in which cleaning media is used.

6. A method for monitoring a CIP process in a CIP system used to clean one or more objects comprising the following units:
a primary tank for primary cleaning media;
optionally a secondary tank for secondary cleaning media;
a supply of freshwater;
one or more forward lines forwarding liquid in form of primary or secondary cleaning media or water from the CIP process plant to one or more objects where one object comprises one unit or a part of a unit such as a tank or pipeline or a combination of units and each object is subjected to a separate CIP flow;
one or more return lines returning liquid in form of primary, or secondary cleaning media or water from the object to the CIP process plant;
valves directing the liquid in and out of tanks and lines of the CIP system, where each forward line comprises valves directing liquid from either the supply of freshwater or from a tank into a forward line, and each return line comprises inlet valves directing liquid from the return line into a tank or into a drain;
wherein the method comprises:
a. measuring concentration of a cleaning media and measuring flow entering into an object;
b. determining a value Vᵢₙ for amount of cleaning media entering the object during a first period where cleaning media flows into the object;
c. measuring concentration of a cleaning media and measuring flow exciting the object; and
d. determining a value Vₒᵤₜ for amount of cleaning media leaving the object during a second period which second period corresponds to the first period in such a way that the cleaning media entering the object in the first period should leave the object during the second period.

7. The method according to claim 6, which process further comprises the following steps:
e. comparing the amount of cleaning media Vₒᵤₜ exciting the object with the amount of cleaning media Vᵢₙ entering the object and determining a difference value ΔV; and
f. determining whether difference value ΔV differs significantly from a standard value V₀.

8. The method according to claim 6, wherein the system generates or sets a Flag, Bit or another digital signal if ΔV differs significantly from the standard value V₀.

9. The method according to claim 6, wherein the standard value V₀ is estimated for a CIP process for an object and used to estimate whether the difference value ΔV differs significantly from a standard value V₀.

10. The method according to claim 9, wherein a first standard value V₀ for cleaning an object is estimated by running one or more CIP process in a clean object, i.e. during this run the object which is to have a standard value V₀ estimated has either been cleaned or has not been used before.

11. The method according to claim 7, wherein the standard value V₀ for cleaning an object is estimated by running a CIP process for the object at least 5 times, or at least 10 times, and calculating a mean value and a standard deviation for the total number of processes, further the standard value V₀ may be improved over time as more CIP processes are run during production by establishing updated values for mean value and standard deviation.

12. The method according to claim 7, wherein the standard value V₀ for cleaning an object is estimated after a first CIP on a clean object. Hereafter the standard value V₀ will continuously be optimized as more data is collected and processed in the database from the CIP controller or other controllers.
